(19) United States
(12) Patent Application Publication
(10) Pub. No.: US 2010/0108639 A1
(43) Pub. Date: May 6, 2010

(54) IMPRINTING MOLD AND METHOD OF PRODUCING IMPRINTING MOLD

(75) Inventor: Osamu Kasono, Tsurugashima-shi (JP)

Correspondence Address: SUGHRUE MION, PLLC, 2100 PENNSYLVANIA AVENUE, N.W., SUITE 800, WASHINGTON, DC, 20037, US

(73) Assignee: Pioneer Corporation, Meguro-ku ,Tokyo (JP)

(21) Appl. No.: 12/593,854

(22) PCT Filed: Mar. 30, 2007
(86) PCT No.: PCT/JP2007/057267

§ 371 Date: Dec. 16, 2009

(51) Int. Cl. B44C 1/22; B29C 59/02

(52) U.S. Cl. 216/41; 425/385

(57) ABSTRACT

An imprinting mold having a recess/protrusion surface. The recess/protrusion surface is made up of a plurality of regions different in the ratio of the area of recesses to the area of protrusions, and a recess/protrusion surface of a region where the recess area percentage is relatively small is formed deeper in recess/protrusion depth than a recess/protrusion surface of a region where the recess area percentage is relatively large.

### TECHNICAL FIELD

The present invention relates to a mold used in nano-imprint lithography (NIL) and a method of producing the same.

### BACKGROUND ART

As a lithography technology usually used for patterning, there exists photolithography, and for the manufacture of a variety of products in small quantities, there exist direct writing by an electron beam, and so on. However, with these lithography technologies, there are respective problems. First, because the photolithography has a limit to its resolution due to the light wavelength, it is difficult to form pattern features of 100 nm or less. The direct writing by an electron beam is lacking in throughput per unit time and hence is not suitable for mass production. In order to overcome the fine-pattern limit and processing capacity of the lithography technology that is the core of these fine structure device making technologies, research into lithography by new means is being actively conducted. In particular, research into nano-imprint lithography technology, which can create design rules of the order of a nanometer and which is a technology suitable for mass production, is attracting attention. This technology is to press a mold having a nanometer-scale recess/protrusion structure onto a resist on a wafer to transfer the structure of the mold to the resist, thereby forming a fine recess/protrusion structure in the resist and, by removing the remaining film, forming a pattern as with the conventional lithography. Because the pattern transfer finishes with the pressing of the mold and the removal of the remaining film, the time required for patterning can be reduced, thus improving throughput, which means that this technology is suitable for mass production.

### Patent Literature 1: Japanese Patent Kokai No. 2005-539393

### Patent Literature 2: Japanese Patent Kokai No. 2005-283814

### DISCLOSURE OF THE INVENTION

### [Problem to be Solved by the Invention]

However, in the case of forming a recess/protrusion surface in subject-to-shaping material such as a resist using a conventional mold, when forming a recess/protrusion pattern with regions where the area occupied by recesses is larger than that occupied by protrusions and regions where the former is smaller than the latter being mixed, namely, when forming a recess/protrusion surface having a plurality of regions different in recess/protrusion area ratio by imprint, it is difficult to form a desired pattern in subject-to-shaping material. Details thereof will be described below with reference to FIGS. 1 and 2.

FIGS. 1 and 2 are cross-sectional views showing an imprint process of forming a single recess/protrusion surface having three regions different in recess/protrusion area ratio. In the nano-imprint process, first, subject-to-shaping material is prepared. A substrate 3 made of desired material and uniformly coated with a resist 2 of, e.g., thermoplastic resin is used as the subject-to-shaping material (FIG. 1 (a)).

Then, after the substrate 3 coated with the resist 2 is heated to soften the resist, a mold 1 is put in contact with the resist 2, and by applying pressure, the resist 2 is deformed. The mold 1 has a recess/protrusion surface made up of three regions different in recess/protrusion area ratio. That is, region 1 is a region where the recess area percentage is relatively large; region 2 is a region where the recess area percentage is medium; and region 3 is a region where the recess area percentage is relatively small. The recess area percentage refers to the ratio of the recess area to the area of the entire recess/protrusion surface of each of the regions of the mold and can be expressed as:

Recess area percentage r=Recess area of the region/(Recess area of the region+Protrusion area of the region), where the recess area refers to the area of recesses of the recess/protrusion surface formed in the mold, and the protrusion area refers to the area of protrusions of the recess/protrusion surface formed in the mold.

Next, keeping the mold 1 pressed onto the resist 2, the substrate temperature is lowered to harden the resist 2, thereby transferring the recess/protrusion pattern of the mold 1 to the resist 2 (FIG. 1 (b)).

Then, after the resist 2 has hardened sufficiently, the mold 1 is separated from the substrate 3 (FIG. 1 (c)). At this time, a remaining film 2a from the resist is left on parts of the substrate 3 corresponding to the protrusions of the mold 1. The thickness of this remaining film 2a is greater in a region of the mold having a smaller recess area percentage. That is, the thickness of the remaining film 2a increases in the order of region 1, region 2, and region 3. This is because a region of the mold having a smaller recess area percentage is smaller in the amount of resist going into the space in a recess of the mold than a region having a larger one. Then, after the mold 1 is separated from the substrate 3, the remaining film 2a is removed by reactive ion etching (RIE) to finish the imprint (FIG. 1 (d)). Here, the etching is performed to completely remove the remaining film 2a left in a region (region 3) of the mold having a relatively small recess area percentage. However, because the thickness of the remaining film is greater in this region than in the other regions as mentioned above, if the etching is performed to completely remove all of this, the etching continues even after the remaining film 2a is completely removed in regions of the mold having a relatively large recess area percentage (regions 1, 2), so that protrusions of the recess/protrusion pattern imprinted in the resist 2 are etched excessively. Thus, there is the problem that in regions of the mold having a relatively large recess area percentage (regions 1, 2), enough recess/protrusion depth (or height) in the patterned recess/protrusion surface cannot be secured.

FIG. 2 shows a case where the initial thickness of the resist 2 coated over the substrate 3 is smaller than in FIG. 1. The process performed in each step is the same as in FIG. 1, and hence description thereof is omitted. In this case, the remaining film 2a from the resist left on the portions corresponding to the protrusions of the mold 1 is substantially uniform over all the regions, but the recess/protrusion depth of the recess/protrusion pattern imprinted in the resist 2 becomes smaller as the recess area percentage becomes larger. That is, the recess/protrusion depth of the recess/protrusion pattern formed in the resist 2 decreases in the order of region 3, region 2, and region 1 (FIG. 2 (c)). Thereafter, the remaining film 2a is etched to finish the imprint, but there is the problem that in the region (region 3) of the mold having a relatively large recess area percentage, the recess/protrusion depth of the recess/protrusion pattern formed in the resist 2 at mold pressing is small and that thus enough recess/protrusion depth cannot be secured.

As described above, with the conventional mold having a recess/protrusion surface made up of a plurality of regions different in recess/protrusion area ratio, the recess/protrusion depth of the recess/protrusion surface is uniform over all the regions, hence causing the above problem.

The present invention was made in view of the above facts, and an object thereof is to provide a mold that, when forming a plurality of regions different in recess/protrusion area ratio in subject-to-shaping material by imprint, can form a recess/protrusion surface having enough recess/protrusion depth in each region, and a method of producing the same.

### [Means for Solving the Problem]

According to the present invention, there is provided an imprinting mold having a recess/protrusion surface. The recess/protrusion surface is made up of a plurality of regions different in the ratio of the area of recesses to the area of protrusions, and a recess/protrusion surface of a region where the area ratio is small is deeper in recess/protrusion depth than a recess/protrusion surface of a region where the area ratio is large.

Further, according to the present invention, there is provided a method of producing the above imprinting mold. The method comprises the steps of preparing a mold substrate having a transfer layer laid over a substrate material; preparing a reference mold having a recess/protrusion surface made up of a plurality of recess/protrusion patterns different in the ratio of the area of recesses to the area of protrusions, corresponding to the plurality of regions respectively, where recess/protrusion depth of its recess/protrusion surface is uniform; pressing the reference mold to transfer the recess/protrusion patterns of the reference mold to the transfer layer and to make the thickness of a remaining film from the transfer layer that is left on parts of the substrate material corresponding to protrusions of the reference mold be different for each of the regions; coating a coating material such as thermoset material over the mold substrate to fill the inner spaces of recesses of the recess/protrusion patterns formed in the transfer layer and then solidifying the coating material such as thermoset material; etching back the coating material such as thermoset material until the tops of protrusions of the recess/protrusion patterns formed in the transfer layer are exposed; and selectively etching the transfer layer with the coating material such as thermoset material as a mask.

Yet further, according to the present invention, there is provided a method of producing the above imprinting mold. The method comprises the steps of preparing a mold substrate having a transfer layer laid over a substrate material; preparing a reference mold having a recess/protrusion surface made up of a plurality of recess/protrusion patterns different in the ratio of the area of recesses to the area of protrusions, corresponding to the plurality of regions respectively, where recess/protrusion depth of its recess/protrusion surface is uniform; pressing the reference mold to transfer the recess/protrusion patterns of the reference mold to the transfer layer and to make the thickness of a remaining film from the transfer layer that is left on parts of the substrate material corresponding to protrusions of the reference mold be different for each of the regions; removing all of the remaining film by etching while, by the etching, making the height of a protrusion of the recess/protrusion patterns formed in the transfer layer be different for each of the regions; coating a coating material such as thermoset material over the mold substrate to fill the inner spaces of recesses of the recess/protrusion patterns formed in the transfer layer and then solidifying the coating material such as thermoset material; etching back the coating material such as thermoset material until the tops of protrusions of the recess/protrusion patterns formed in the transfer layer are exposed; and selectively etching the transfer layer with the coating material such as thermoset material as a mask.

Still further, according to the present invention, there is provided a method of producing the above imprinting mold. The method comprises the steps of preparing a mold substrate having a transfer layer laid over a substrate material; preparing a reference mold having a recess/protrusion surface made up of a plurality of recess/protrusion patterns different in the ratio of the area of recesses to the area of protrusions, corresponding to the plurality of regions respectively, where recess/protrusion depth of its recess/protrusion surface is uniform; pressing the reference mold to transfer the recess/protrusion patterns of the reference mold to the transfer layer and to make the thickness of a remaining film from the transfer layer that is left on parts of the substrate material corresponding to protrusions of the reference mold be different for each of the regions; removing part of the remaining film by etching; coating a coating material such as thermoset material over the mold substrate to fill the inner spaces of recesses of the recess/protrusion patterns formed in the transfer layer and then solidifying the coating material such as thermoset material; etching back the coating material such as thermoset material until the tops of protrusions of the recess/protrusion patterns formed in the transfer layer are exposed; and selectively etching the transfer layer with the coating material such as thermoset material as a mask.

Further, according to the present invention, there is provided a method of producing the above imprinting mold. The method comprises the steps of preparing a mold substrate having a transfer layer laid over a substrate material; preparing a reference mold having a recess/protrusion surface made up of a plurality of recess/protrusion patterns different in the ratio of the area of recesses to the area of protrusions, corresponding to the plurality of regions respectively, where recess/protrusion depth of its recess/protrusion surface is uniform; pressing the reference mold to transfer the recess/protrusion patterns of the reference mold to the transfer layer; removing, by etching, all of a remaining film from the transfer layer that is left on parts of the substrate material corresponding to protrusions of the reference mold; coating a coating material such as thermoset material over the mold substrate to fill the inner spaces of recesses of the recess/protrusion patterns formed in the transfer layer and then solidifying the coating material such as thermoset material; etching back the coating material such as thermoset material until the tops of protrusions of the recess/protrusion patterns formed in the transfer layer are exposed; and selectively etching the transfer layer with the coating material such as thermoset material as a mask.

### BRIEF DESCRIPTION OF DRAWINGS

FIG. 1 is cross-sectional views showing an imprint process using a conventional mold;

FIG. 2 is cross-sectional views showing an imprint process using the conventional mold;

FIG. 3 is a cross-sectional view of an imprinting mold according to the present invention;

FIG. 4 is cross-sectional views showing an imprint process using the mold according to the present invention;

FIG. 5 is cross-sectional views showing an imprint process using a mold according to the present invention;

FIG. 6 is a process chart showing the method of producing an imprint mold according to a first embodiment of the present invention;

FIG. 7 is a process chart showing the method of producing an imprint mold according to a second embodiment of the present invention;

FIG. 8 is a process chart showing the method of producing an imprint mold according to a third embodiment of the present invention;

FIG. 9 is a process chart showing the method of producing an imprint mold according to a fourth embodiment of the present invention;

FIG. 10 is a perspective view showing the structure of a discrete track medium; and

FIG. 11 is a process chart for producing a discrete track medium using a mold according to the present invention.

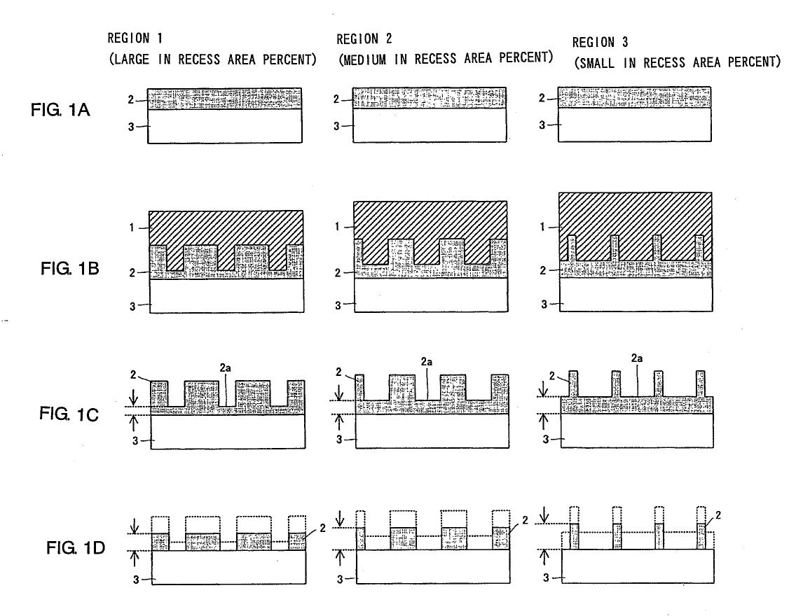

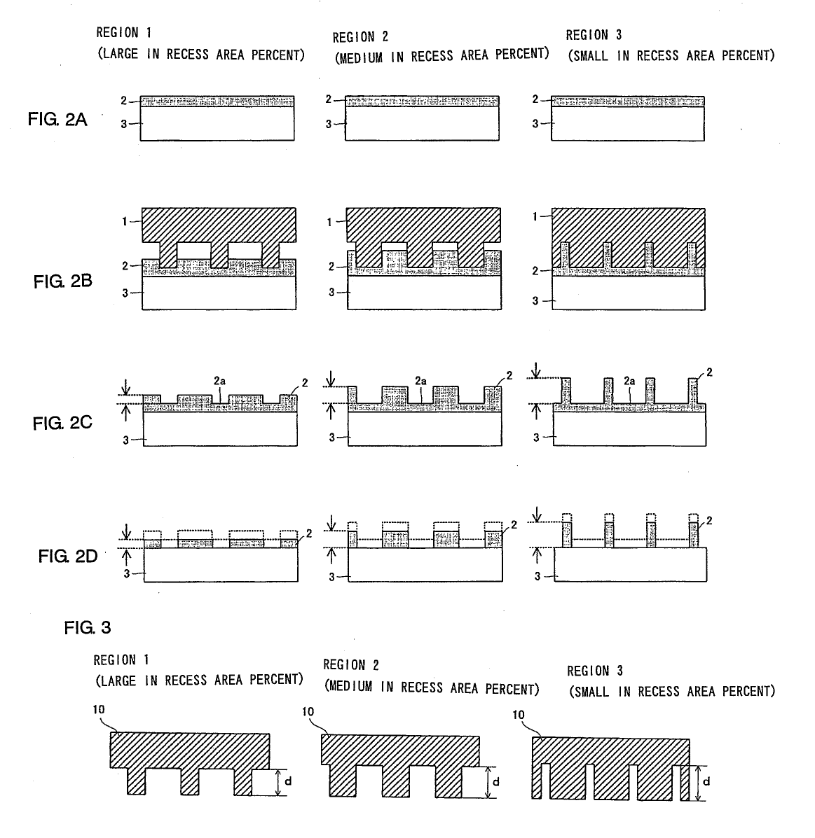

### EXPLANATION OF REFERENCE NUMERALS

1 Mold
10 Mold
10a to 10d Mold
20 NIL resist
20a Resist remaining film
30 Substrate
40 SOG
50a Nickel film
50b Nickel film

### DETAILED DESCRIPTION OF THE INVENTION

Embodiments of the present invention will be described below with reference to the drawings. The same reference numerals are used to denote substantially the same or equivalent constituents or parts throughout the figures cited below. For convenience of description for each region, the regions are shown separately, but in practice they are integrally formed.

First, the configuration of the mold according to the present invention will be described. FIG. 3 is a cross-sectional view showing the configuration of the mold 10 according to the present invention. In the mold 10, there is formed a recess/protrusion surface made up of, e.g., three regions different in recess/protrusion area ratio. In FIG. 3, region 1 is a region of the mold where the recess area percentage is relatively large; region 2 is a region of the mold where the recess area percentage is medium; and region 3 is a region of the mold where the recess area percentage is relatively small. The recess area percentage refers to the ratio of the recess area to the area of the entire recess/protrusion surface of each of the regions of the mold 10 and can be expressed as:

Recess area percentage r=Recess area of the region/(Recess area of the region+Protrusion area of the region), where the recess area refers to the area of recesses of the recess/protrusion surface formed in the mold 10, and the protrusion area refers to the area of protrusions of the recess/protrusion surface formed in the mold. In this embodiment, the recess area percentage r of region 1 is, for example, 0.75; the recess area percentage of region 2 is, for example, 0.5; and the recess area percentage of region 3 is, for example, 0.25. Meanwhile, the recess/protrusion depth d of the recess/protrusion surface formed in the mold 10 differs between regions 1 to 3. That is, the recess/protrusion depth d of the recess/protrusion surface formed in the mold 10 is larger in a region having a smaller recess area percentage and smaller in a region having a larger recess area percentage. Specifically, it is desirable that the recess/protrusion surface of the mold 10 be formed so as to establish an inversely proportional relationship between the recess/protrusion depth d and the recess area percentage r. That is, since the recess area percentage r of regions 1 to 3 is 0.75, 0.5, and 0.25 respectively as mentioned above, it is desirable that the recess/protrusion surface be formed such that, as to the recess/protrusion depth d of the recess/protrusion surface, a ratio relationship of 1.33:2:4 is established between regions 1 to 3. In other words, the recess/protrusion depth d should be set such that the volume of the inner space of each recess of the recess/protrusion surface is the same over all the regions.

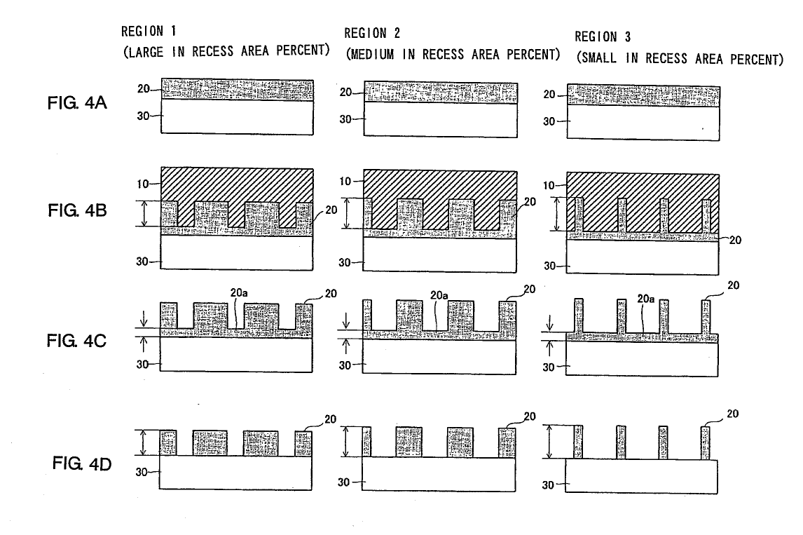

FIG. 4 is cross-sectional views showing the imprint process of forming a recess/protrusion pattern in subject-to-shaping material using the mold 10 having the recess/protrusion surface whose recess/protrusion depth differs according to the recess area percentage as described above. A recess/protrusion pattern obtained by using the mold 10 will be described below with reference to FIG. 4.

First, subject-to-shaping material is prepared. A substrate 30 uniformly coated with an NIL resist 20 is used as the subject-to-shaping material (FIG. 4 (a)).

Then, after the substrate 30 coated with the NIL resist 20 is heated to soften the resist, a mold 10 is put in contact with the resist 20, and by applying pressure, the resist 20 is deformed. Then, keeping the mold pressed, the substrate temperature is lowered to harden the resist 20, thereby transferring the recesses/protrusions of the mold 10 to the resist 20 (FIG. 4 (b)).

Then, after the resist 20 has hardened sufficiently, the mold 10 is separated from the substrate 30 (FIG. 4 (c)). At this time, a remaining film 20a from the resist 20 is left on parts of the substrate 30 corresponding to the protrusions of the mold 10. By using the mold 10 according to the present invention, the thickness of the remaining film 20a is substantially uniform over regions 1 to 3. This is because the recess/protrusion depth d of each region of the mold 10 is adjusted according to the recess area percentage r. That is, the reason is that because the recess/protrusion depth d has an inversely proportional relationship with the recess area percentage r, the volume of resist going into the space in a recess of the mold 10 is substantially the same for each region.

Then, after the mold 10 is separated from the substrate 30, etching is performed using reactive ion etching (RIE) to remove all of the remaining film 20a, thereby finish the imprint (FIG. 4 (d)). In this embodiment, because the thickness of the remaining film 20a is substantially uniform over regions 1 to 3, there is solved the problem that in regions of the mold having a relatively large recess area percentage (regions 1, 2), the recess/protrusion pattern imprinted in the resist 20 is over-etched and that thus enough recess/protrusion depth (or height) cannot be secured. The final recess/protrusion pattern of the resist 20 obtained after the etching process is a precise duplicate of the recess/protrusion pattern formed in the mold 10, over all the regions.

As such, when forming a recess/protrusion surface having a plurality of regions different in recess/protrusion area ratio in subject-to-shaping material by imprint, by using a mold where in regions of the mold having a relatively small recess area percentage the recess/protrusion depth is made deeper and where in regions of the mold having a relatively large recess area percentage the recess/protrusion depth is made shallower, the volume of resist going into a recess of the mold when imprinted is substantially the same over the regions, and thus the thickness of the remaining film from the resist left on parts corresponding to the protrusions of the mold is substantially uniform over all the regions. Therefore, there is solved the problem with the conventional art that because the thickness of the remaining film is different for each region, an over-etched region occurs and that thus enough recess/protrusion depth of the recess/protrusion pattern formed in the region cannot be secured.

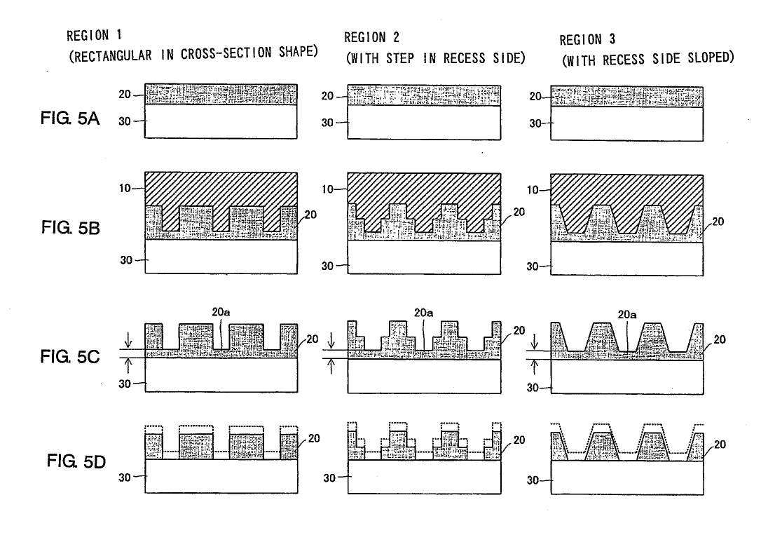

In the above embodiment, the case where the cross-section shape of the recess/protrusion pattern formed in the mold is rectangular has been described, but the present invention is not limited to this. FIG. 5 is cross-sectional views showing the production process when imprinting in subject-to-shaping material using a mold 10′ having a recess/protrusion surface made up of a plurality of regions different in cross-section shape. Also in this case, by setting the recess/protrusion depth such that the volume of the inner space of each recess of the recess/protrusion surface formed in the mold 10′ is the same over the regions, the thickness of the remaining film 20a can be made uniform over all the regions, thus solving the problem with the conventional art as described above.

Next, a method of producing a mold where the recess/protrusion depth varies according to the recess/protrusion area ratio as shown in FIG. 3 will be described below. Although the above description has mentioned that it is desirable that the recess/protrusion surface of the mold 10 be formed so as to establish an inversely proportional relationship between the recess/protrusion depth d and the recess area percentage r, this is not exactly implemented in the mold produced by the producing method described below. A method of producing a mold having a tendency where a region having a smaller recess area percentage has a larger recess/protrusion depth will be described below. Even with this mold, the effect of improving to some extent the above problem as occurs with the use of the conventional mold can be expected.

### Embodiment 1

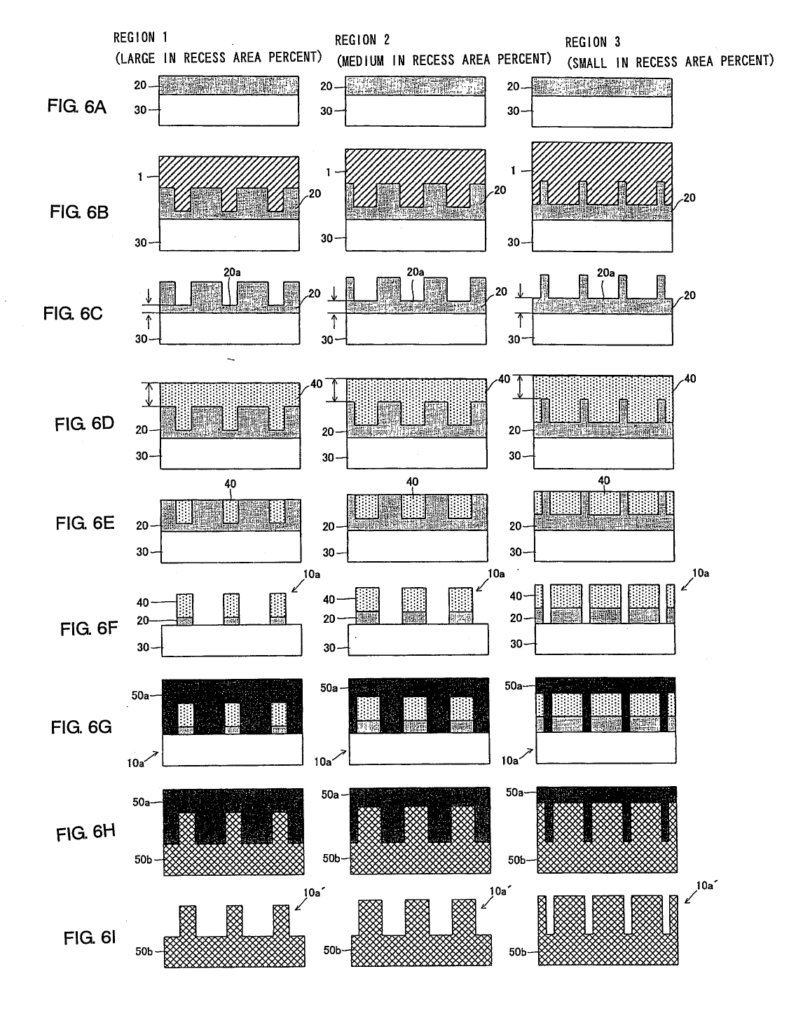

A first embodiment of the method of producing a mold according to the present invention will be described with reference to FIG. 6. First, a mold substrate forming the base of the mold to be produced is prepared. A substrate 30 made of, e.g., silicon, ceramic, or the like and uniformly coated with an NIL resist 20 as a transfer layer by, e.g., a spin coat method is used as the mold substrate. As the NIL resist 20, light curing resin or thermoplastic resin can be used, and in this embodiment, thermoplastic resin is used. As the thermoplastic resin, for example, polymethyl methacrylate (PMMA) or polystyrene (PS) can be used (FIG. 6 (a)).

Then, the substrate 30 coated with the NIL resist 20 is heated to about 200° C. to soften the NIL resist 20. Next, a conventional mold 1, where a recess/protrusion surface made up of a plurality of regions different in recess/protrusion area ratio is formed, is put in contact with the softened NIL resist 20, and by applying pressure, the NIL resist 20 is deformed. Then, keeping the mold pressed, the substrate temperature is lowered to harden the resist 20, thereby transferring the recess/protrusion pattern of the mold 1 to the NIL resist 20 (FIG. 6 (b)). Here, the mold 1 has, e.g., three regions different in recess/protrusion area ratio, and region 1 is a region of the mold where the recess area percentage is relatively large; region 2 is a region of the mold where the recess area percentage is medium; and region 3 is a region of the mold where the recess area percentage is relatively small. The recess/protrusion depth of the recess/protrusion surface is uniform over regions 1 to 3. Note that the mold 1 is formed by coating a resist over, e.g., a thermally oxidized silicon film and patterning the resist by electron beam direct writing and, with the resist as a mask, performing dry etching, and that the widths of the protrusions and recesses of the recess/protrusion surface thereof are 1 μm or less.

After the NIL resist 20 has hardened sufficiently, the mold 1 is separated from the substrate 30 (FIG. 6 (c)). At this time, a remaining film 20a from the NIL resist 20 is left on parts of the substrate 30 corresponding to the protrusions of the mold 1. The thickness of this remaining film 20a is greater in a region of the mold 1 having a smaller recess area percentage. That is, the thickness of the remaining film 20a increases in the order of region 1, region 2, and region 3. Note that the initial thickness of the NIL resist 20 is set so as to produce these differences in the thickness of the remaining film 20a.

Then, SOG (Spin On Glass) is coated over the subject-to-shaping material having the recess/protrusion pattern formed therein to form an SOG film 40. At this time, the SOG is coated such that the spaces in the recesses formed in the NIL resist 20 are filled with SOG and that the thickness (indicated by an arrow in FIG. 6 (d)) of the SOG film measured from the top of a protrusion of the NIL resist 20 is uniform over the regions. Next, the solvent of the SOG film 40 is dried at a temperature (60 to 120° C., preferably 80 to 100° C.) less than or equal to a glass transition temperature Tg of the NIL resist 20 to cause a partial polymerization reaction (FIG. 6 (d)).

Then, the SOG film 40 is etched back by dry etching using fluorocarbon such as CF₄ or CHF₃ as etching gas until the tops of the protrusions of the NIL resist 20 below are exposed (FIG. 6 (e)).

Next, only the NIL resist 20 is selectively etched by reactive ion etching (RIE) with O₂ plasma or the like (FIG. 6 (f)). By undergoing the above steps, a mold 10a is finished. Thereafter, the substrate 30 may be etched with the SOG film 40 as a mask as needed.

The recess/protrusion pattern formed in each region of the mold 10a produced by the above producing method takes on the recess/protrusion area ratio of the recess/protrusion pattern formed in the original mold 1 as it is. The recess/protrusion depth is different for each region according to the thickness difference of the resist remaining film 20a formed when the original mold 1 is pressed. That is, a recess/protrusion surface having a plurality of regions different in recess/protrusion area ratio is formed in the mold 10a, and the recess/protrusion depth of the recess/protrusion surface is deeper in a region having a smaller recess area percentage. The widths of the protrusions and recesses of the recess/protrusion surface thereof are 1 μm or less as in the original mold 1.

Using the finished mold 10a as a master, a nickel mold in the same shape as this, may be produced. FIG. 6 (g) to (i) show the steps until obtaining a nickel mold 10a′ from the finished mold 10a. The nickel mold 10a′ is obtained by performing electroforming two times. That is, a nickel film 50a is electrodeposited over the surface of the mold 10a as a master by electroforming (FIG. 6 (g)). Then, the nickel film 50a is separated from the master. Thereby, a mold having the inverse of the recess/protrusion pattern of the master can be obtained. Next, a nickel film 50b is electrodeposited over the surface of the nickel film 50a by electroforming (FIG. 6 (h)). Then these are separated to finish the nickel mold 10a′. By this means, a mold having completely the same shape as the mold 10a that is a master and further having heat resistance can be obtained.

### Embodiment 2

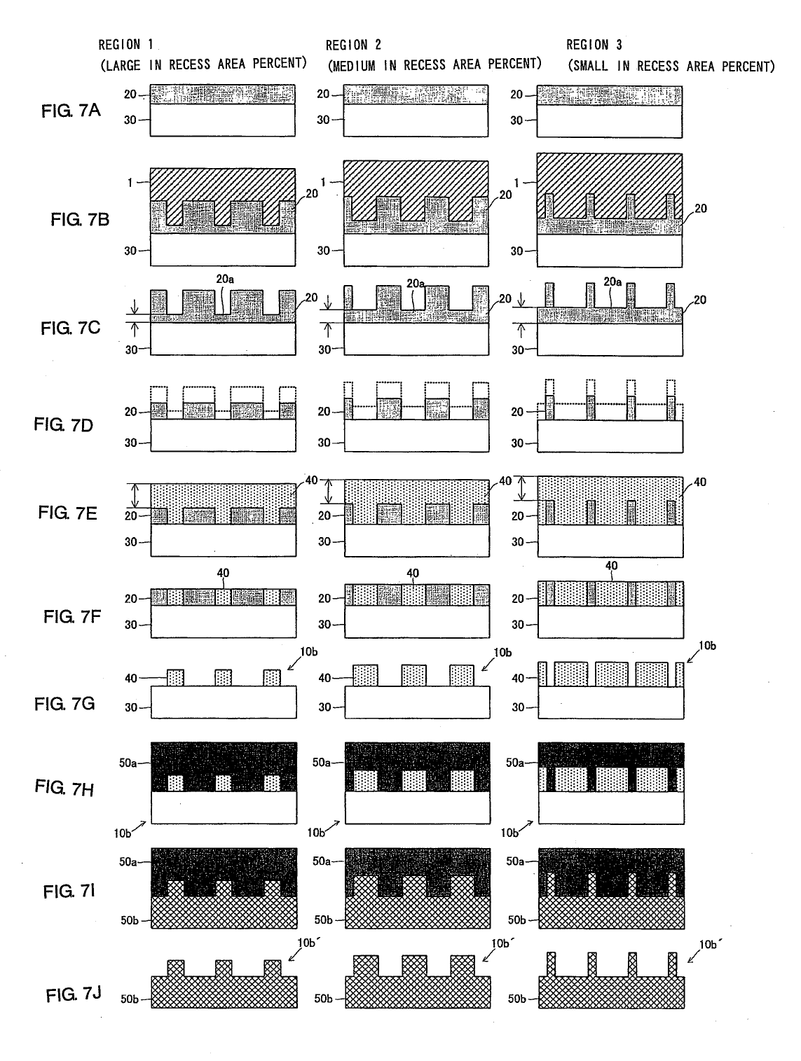

A second embodiment of the method of producing a mold according to the present invention will be described with reference to FIG. 7. First, a mold substrate forming the base of the mold to be produced is prepared. A substrate 30 uniformly coated with an NIL resist 20 as a transfer layer by, e.g., a spin coat method is used as the mold substrate. As the NIL resist 20, light curing resin or thermoplastic resin can be used, and in this embodiment, thermoplastic resin is used. As the thermoplastic resin, for example, polymethyl methacrylate (PMMA) or polystyrene (PS) can be used (FIG. 7 (a)).

Then, the substrate 30 coated with the NIL resist 20 is heated to about 200° C. to soften the NIL resist 20. Next, a conventional mold 1, where a recess/protrusion surface made up of a plurality of regions different in recess/protrusion area ratio is formed, is put in contact with the softened NIL resist 20, and by applying pressure, the NIL resist 20 is deformed. Then, keeping the mold pressed, the substrate temperature is lowered to harden the resist 20, thereby transferring the recess/protrusion pattern of the mold 1 to the NIL resist 20 (FIG. 7 (b)). The mold 1 has, e.g., three regions different in recess/protrusion area ratio, and region 1 is a region of the mold where the recess area percentage is relatively large; region 2 is a region of the mold where the recess area percentage is medium; and region 3 is a region of the mold where the recess area percentage is relatively small. The recess/protrusion depth of the recess/protrusion surface is uniform over regions 1 to 3. Note that the mold 1 is formed by coating a resist over, e.g., a thermally oxidized silicon film and patterning the resist by electron beam direct writing and, with the resist as a mask, performing dry etching, and that the widths of the protrusions and recesses of the recess/protrusion surface thereof are 1 μm or less.

After the NIL resist 20 has hardened sufficiently, the mold 1 is separated from the substrate 30 (FIG. 7 (c)). At this time, a remaining film 20a from the NIL resist is left on parts of the substrate 30 corresponding to the protrusions of the mold 1. The thickness of this remaining film 20a is greater in a region of the mold 1 having a smaller recess area percentage. That is, the thickness of the remaining film 20a increases in the order of region 1, region 2, and region 3. Note that the initial thickness of the NIL resist 20 is set so as to produce these differences in the thickness of the remaining film 20a.

Next, etching is performed so as to completely remove the remaining film 20a formed in region 3 by reactive ion etching (RIE) with O₂ plasma or the like (FIG. 7 (d)). By this etching process, in regions 1 and 2, even after their remaining film 20a is completely removed, etching continues so that the protrusions of the patterned NIL resist 20 are further etched. Thus, the height thereof decreases in the order of region 3, region 2, and region 1.

Then, SOG (Spin On Glass) is coated over the subject-to-shaping material having the recess/protrusion pattern formed therein, filling the recesses to form an SOG film 40. At this time, the SOG is coated such that the thickness (indicated by an arrow in FIG. 7 (e)) measured from the top of a protrusion of the patterned NIL resist 20 is uniform over the regions. Next, the solvent of the SOG film 40 is dried at a temperature (60 to 120° C., preferably 80 to 100° C.) less than or equal to a glass transition temperature Tg of the NIL resist 20 to cause a partial polymerization reaction (FIG. 7 (e)).

Then, the SOG film 40 is etched back by dry etching using fluorocarbon such as CF₄ or CHF₃ as etching gas until the tops of the protrusions of the NIL resist 20 below are exposed (FIG. 7 (f)).

Next, only the NIL resist 20 is selectively etched by reactive ion etching (RIE) with O₂ plasma or the like (FIG. 7 (g)). By undergoing the above steps, a mold 10b is finished. Thereafter, the substrate 30 may be etched with the SOG film 40 as a mask as needed. Further, by using a light transmissive material such as glass as the substrate 30, the mold 10b could also be used as a mold with which to form a pattern in light curing resin.

The recess/protrusion pattern formed in each region of the mold 10b produced by the above producing method takes on the recess/protrusion area ratio of the recess/protrusion pattern formed in the original mold 1 as it is. The recess/protrusion depth is different for each region according to the thickness difference of the resist remaining film 20a formed when the original mold 1 is pressed. That is, a recess/protrusion surface having a plurality of regions different in recess/protrusion area ratio is formed in the mold 10b, and the recess/protrusion depth of the recess/protrusion surface is deeper in a region having a smaller recess area percentage. The widths of the protrusions and recesses of the recess/protrusion surface thereof are 1 μm or less as in the original mold 1.

Using the finished mold 10b as a master, a nickel mold in the same shape as this, may be produced. FIG. 7 (h) to (j) show the steps until obtaining a nickel mold 10b′ from the finished mold 10b. The nickel mold 10b′ is obtained by performing electroforming two times. That is, a nickel film 50a is electrodeposited over the surface of the mold 10b as a master by electroforming (FIG. 7 (h)). Then, the nickel film 50a is separated from the master. Thereby, a mold having the inverse of the recess/protrusion pattern of the master can be obtained. Next, a nickel film 50b is electrodeposited over the surface of the nickel film 50a by electroforming (FIG. 7 (i)). Then these are separated to finish the nickel mold 10b′. By this means, a mold having completely the same shape as the mold 10b that is a master and further having heat resistance can be obtained.

### Embodiment 3

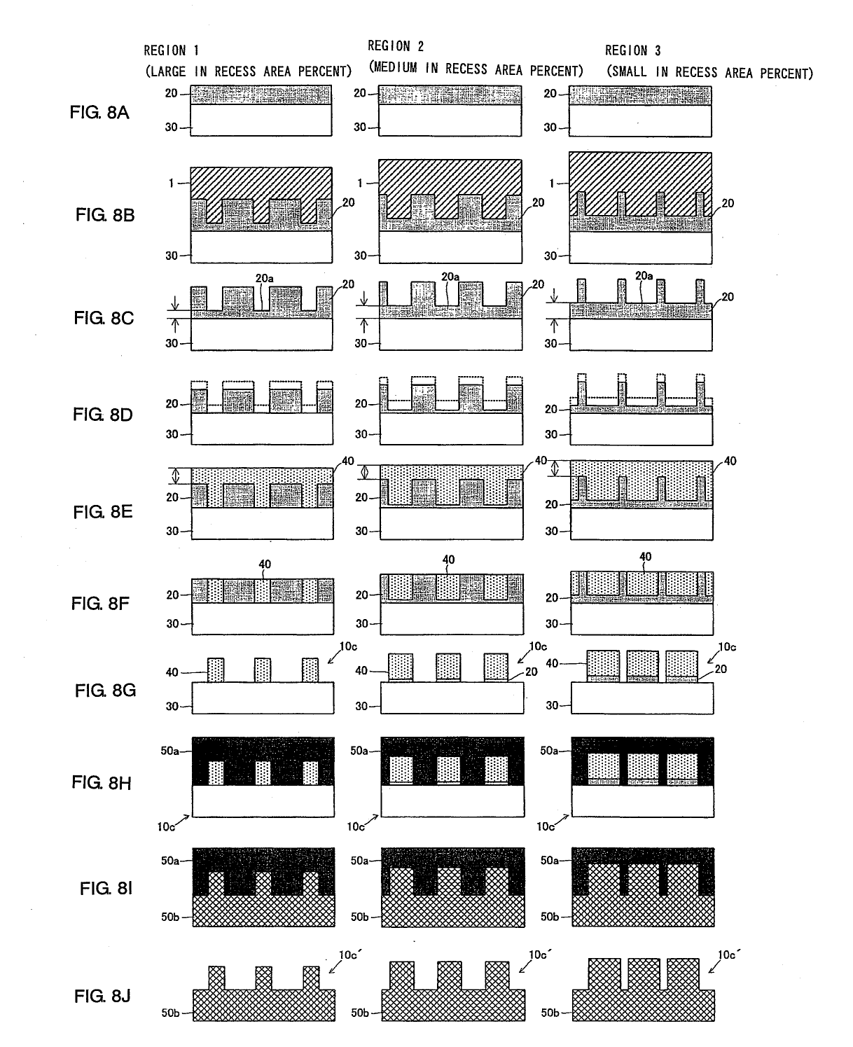

A third embodiment of the method of producing a mold according to the present invention will be described with reference to FIG. 8. First, a mold substrate forming the base of the mold to be produced is prepared. A substrate 30 uniformly coated with an NIL resist 20 as a transfer layer by, e.g., a spin coat method is used as the mold substrate. As the NIL resist 20, light curing resin or thermoplastic resin can be used, and in this embodiment, thermoplastic resin is used. As the thermoplastic resin, for example, polymethyl methacrylate (PMMA) or polystyrene (PS) can be used (FIG. 8 (a)).

Then, the substrate 30 coated with the NIL resist 20 is heated to about 200° C. to soften the NIL resist 20. Next, a conventional mold 1, where a recess/protrusion surface made up of a plurality of regions different in recess/protrusion area ratio is formed, is put in contact with the softened NIL resist 20, and by applying pressure, the NIL resist 20 is deformed. Then, keeping the mold pressed, the substrate temperature is lowered to harden the resist 20, thereby transferring the recess/protrusion pattern of the mold 1 to the NIL resist 20 (FIG. 8 (b)). The mold 1 has, e.g., three regions different in recess/protrusion area ratio, and region 1 is a region of the mold where the recess area percentage is relatively large; region 2 is a region of the mold where the recess area percentage is medium; and region 3 is a region of the mold where the recess area percentage is relatively small. The recess/protrusion depth of the recess/protrusion surface is uniform over regions 1 to 3. Note that the mold 1 is formed by coating a resist over, e.g., a thermally oxidized silicon film and patterning the resist by electron beam direct writing and, with the resist as a mask, performing dry etching, and that the widths of the protrusions and recesses of the recess/protrusion surface thereof are 1 μm or less.

After the NIL resist 20 has hardened sufficiently, the mold 1 is separated from the substrate 30 (FIG. 8 (c)). At this time, a remaining film 20a from the NIL resist 20 is left on parts of the substrate 30 corresponding to the protrusions of the mold 1. The thickness of this remaining film 20a is greater in a region of the mold 1 having a smaller recess area percentage. That is, the thickness of the remaining film 20a increases in the order of region 1, region 2, and region 3. Note that the initial thickness of the NIL resist 20 after coated is set so as to produce these differences in the thickness of the remaining film 20a.

Next, etching is performed so as to completely remove the remaining film 20a formed in region 1 by reactive ion etching (RIE) with O₂ plasma or the like (FIG. 8 (d)). That is, while the relatively thin remaining film formed in region 1 is completely removed by this etching process, in regions 2 and 3, the remaining film 20a still remains after this etching process. The thickness of the remaining film 20a after this etching process is greater in region 3 than in region 2.

Then, SOG (Spin On Glass) is coated over the subject-to-shaping material having the recess/protrusion pattern formed therein, filling the recesses to form an SOG film 40. At this time, the SOG is coated such that the thickness (indicated by an arrow in FIG. 8 (e)) measured from the top of a protrusion of the patterned NIL resist 20 is uniform over the regions. Next, the solvent of the SOG film 40 is dried at a temperature (60 to 120° C., preferably 80 to 100° C.) less than or equal to a glass transition temperature Tg of the NIL resist 20 to cause a partial polymerization reaction (FIG. 8 (e)).

Then, the SOG film 40 is etched back by dry etching using fluorocarbon such as CF₄ or CHF₃ as etching gas until the tops of the protrusions of the NIL resist 20 below are exposed (FIG. 8 (f)).

Next, only the NIL resist 20 is selectively etched by reactive ion etching (RIE) with O₂ plasma or the like (FIG. 8 (g)). By undergoing the above steps, a mold 10c is finished. Thereafter, the substrate 30 may be etched with the SOG film 40 as a mask as needed.

The recess/protrusion pattern formed in each region of the mold 10c produced by the above producing method takes on the recess/protrusion area ratio of the recess/protrusion pattern formed in the original mold 1 as it is. The recess/protrusion depth is different for each region according to the thickness difference of the resist remaining film 20a formed when the original mold 1 is pressed. That is, a recess/protrusion surface having a plurality of regions different in recess/protrusion area ratio is formed in the mold 10c, and the recess/protrusion depth of the recess/protrusion surface is deeper in a region having a smaller recess area percentage. The widths of the protrusions and recesses of the recess/protrusion surface thereof are 1 μm or less as in the original mold 1.

Using the finished mold 10c as a master, a nickel mold in the same shape as this, may be produced. FIG. 8 (h) to (j) show the steps until obtaining a nickel mold 10c′ from the finished mold 10c. The nickel mold 10c′ is obtained by performing electroforming two times. That is, a nickel film 50a is electrodeposited over the surface of the mold 10c as a master by electroforming (FIG. 8 (h)). Then, the nickel film 50a is separated from the master. Thereby, a mold having the inverse of the recess/protrusion pattern of the master can be obtained. Next, a nickel film 50b is electrodeposited over the surface of the nickel film 50a by electroforming (FIG. 8 (i)). Then these are separated to finish the nickel mold 10c′. By this means, a mold having completely the same shape as the mold 10c that is a master and further having heat resistance can be obtained.

### Embodiment 4

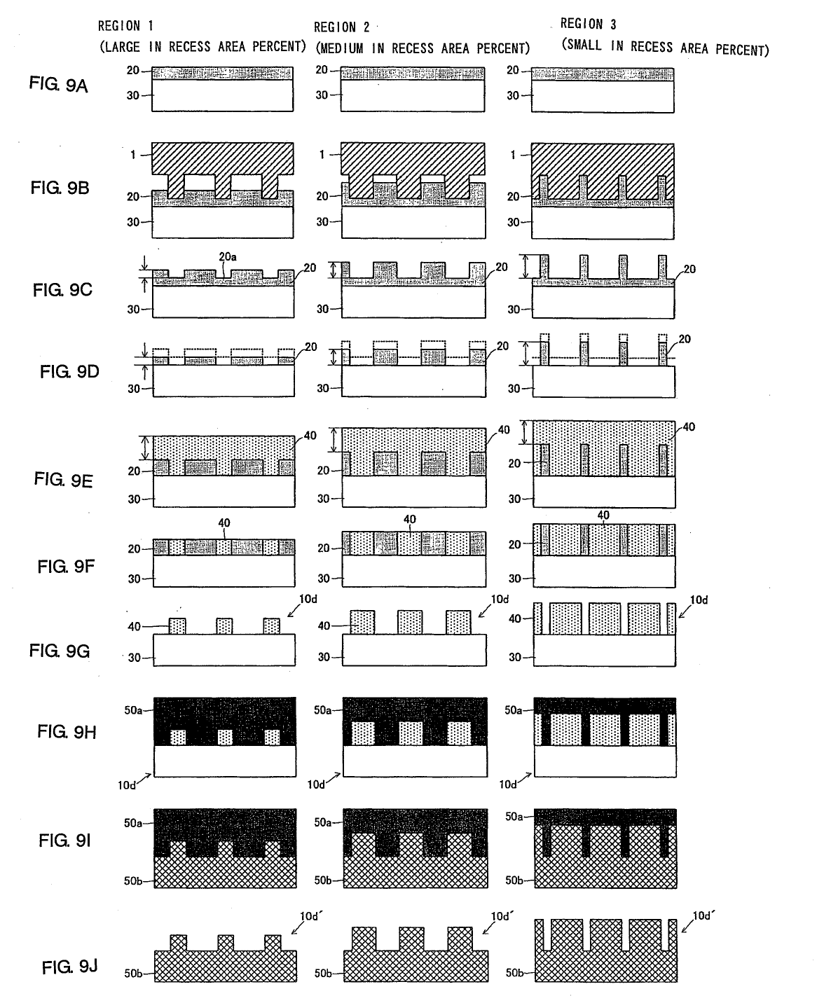

A fourth embodiment of the method of producing a mold according to the present invention will be described with reference to FIG. 9. First, a mold substrate forming the base of the mold to be produced is prepared. A substrate 30 uniformly coated with an NIL resist 20 as a transfer layer by, e.g., a spin coat method is used as the mold substrate. The thickness of the NIL resist 20 is set smaller than in the above embodiments. To be specific, as shown in FIG. 9 (b), the thickness is set at a minimum necessary value to completely fill the insides of the mold recesses formed in region 3 of a mold 1 described later with the NIL resist 20. That is, the initial thickness is set such that the inner spaces of the mold recesses in regions 1 and 2 are not completely filled with the NIL resist 20. As the NIL resist 20, light curing resin or thermoplastic resin can be used, and in this embodiment, thermoplastic resin is used. As the thermoplastic resin, for example, polymethyl methacrylate (PMMA) or polystyrene (PS) can be used (FIG. 9 (a)).

Then, the substrate 30 coated with the NIL resist 20 is heated to about 200° C. to soften the NIL resist 20. Next, a conventional mold 1, where a recess/protrusion surface made up of a plurality of regions different in recess/protrusion area ratio is formed, is put in contact with the softened NIL resist 20, and by applying pressure, the NIL resist 20 is deformed. Then, keeping the mold pressed, the substrate temperature is lowered to harden the resist 20, thereby transferring the recess/protrusion pattern of the mold 1 to the NIL resist 20 (FIG. 9 (b)). The mold 1 has, e.g., three regions different in recess/protrusion area ratio, and region 1 is a region of the mold where the recess area percentage is relatively large; region 2 is a region of the mold where the recess area percentage is medium; and region 3 is a region of the mold where the recess area percentage is relatively small. The recess/protrusion depth of the recess/protrusion surface is uniform over regions 1 to 3. Note that the mold 1 is formed by coating a resist over, e.g., a thermally oxidized silicon film and patterning the resist by electron beam direct writing and, with the resist as a mask, performing dry etching, and that the widths of the protrusions and recesses of the recess/protrusion surface thereof are 1 μm or less.

After the NIL resist 20 has hardened sufficiently, the mold 1 is separated from the substrate 30 (FIG. 9 (c)). At this time, a remaining film 20a from the NIL resist is left on parts of the substrate 30 corresponding to the protrusions of the mold 1. The thickness of this remaining film 20a is substantially uniform over all the regions unlike in the above embodiments 1 to 3. Meanwhile, the thickness (indicated by an arrow in FIG. 9 (c)) measured from the top of this remaining film 20a to the top of a protrusion of the patterned NIL resist 20 is different for each region and increases in the order of region 1, region 2, and region 3.

Next, etching is performed so as to completely remove the remaining film 20a formed in each region by dry etching with O₂ plasma or the like (FIG. 9 (d)). By this means, protrusions of the NIL resist 20 whose thickness is different for each region remain on the substrate 30, and the thickness thereof increases in the order of region 1, region 2, and region 3.

Then, SOG (Spin On Glass) is coated over the subject-to-shaping material having the recess/protrusion pattern formed therein, filling the recesses to form an SOG film 40. At this time, the SOG is coated such that the thickness (indicated by an arrow in FIG. 9 (e)) measured from the top of a protrusion of the patterned NIL resist 20 is uniform over the regions. Next, the solvent of the SOG film 40 is dried at a temperature (60 to 120° C., preferably 80 to 100° C.) less than or equal to a glass transition temperature Tg of the NIL resist 20 to cause a partial polymerization reaction (FIG. 9 (e)).

Then, the SOG film 40 is etched back by dry etching using fluorocarbon such as CF₄ or CHF₃ as etching gas until the tops of the protrusions of the NIL resist 20 below are exposed (FIG. 9 (f)).

Next, only the NIL resist 20 is selectively etched by reactive ion etching with O₂ plasma or the like (FIG. 9 (g)). By undergoing the above steps, a mold 10d is finished. Thereafter, the substrate 30 may be etched with the SOG film 40 as a mask as needed. Further, by using a light transmissive material such as glass as the substrate 30, the mold 10d could also be used as a mold with which to form a pattern in light curing resin.

The recess/protrusion pattern formed in each region of the mold 10d produced by the above producing method takes on the recess/protrusion area ratio of the recess/protrusion pattern formed in the original mold 1 as it is. The recess/protrusion depth is different for each region according to the difference in the recess/protrusion depth of the recess/protrusion pattern formed in the resist 20 when the original mold 1 is pressed. That is, a recess/protrusion surface having a plurality of regions different in recess/protrusion area ratio is formed in the mold 10d, and the recess/protrusion depth of the recess/protrusion surface is deeper in a region having a smaller recess area percentage. The widths of the protrusions and recesses of the recess/protrusion surface thereof are 1 μm or less as in the original mold 1.

Using the finished mold 10d as a master, a nickel mold in the same shape as this, may be produced. FIG. 9 (h) to (j) show the steps until obtaining a nickel mold 10d′ from the finished mold 10d. The nickel mold 10d′ is obtained by performing electroforming two times. That is, a nickel film 50a is electrodeposited over the surface of the mold 10d as a master by electroforming (FIG. 9 (h)). Then, the nickel film 50a is separated from the master. Thereby, a mold having the inverse of the recess/protrusion pattern of the master can be obtained. Next, a nickel film 50b is electrodeposited over the surface of the nickel film 50a by electroforming (FIG. 9 (i)). Then these are separated to finish the nickel mold 10b′. By this means, a mold having completely the same shape as the mold 10d that is a master and further having heat resistance can be obtained.

The SOG used in the above embodiments is preferably, for example, AZ Spinfill (trademark) (component: polysilazane) or DowCorning Fox (trademark) (component: hydrogen silsesquioxane (HSQ)).

Although in the above embodiments description has been made taking as an example a case where SOG that is thermosetting is used as coating material for the recess/protrusion structure, a material which can coat the recess/protrusion pattern and has etching selectivity in a subsequent step can be used as the coating material, not being limited to SOG. For example, if light curing resin or water-soluble resin is used, when being coated, the resin can be coated without dissolving the NIL resist of the recess/protrusion pattern.

As apparent from the above description, according to the method of producing a mold according to the present invention, by using a conventional mold having a recess/protrusion surface made up of a plurality of regions different in recess/protrusion area ratio where the recess/protrusion depth of the recess/protrusion surface is uniform over the regions, a new mold can be produced which has a recess/protrusion surface of the same recess/protrusion area ratio as that of the recess/protrusion surface of the conventional mold for each region and whose recess/protrusion depth differs according to the recess/protrusion area ratio. Further, when a recess/protrusion pattern of a different recess/protrusion depth is formed in each region, the thickness difference of the remaining film or the difference in the recess/protrusion depth of the recess/protrusion pattern, which is formed in the resist by using the conventional mold, is used. Hence, it is easy to adjust it by etching or so on.

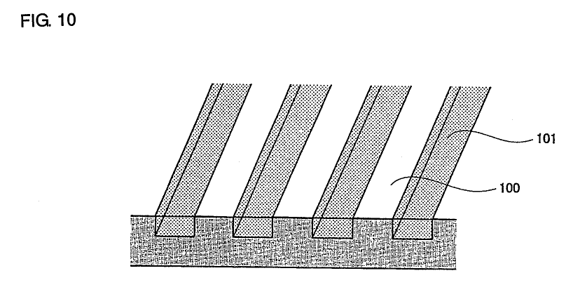

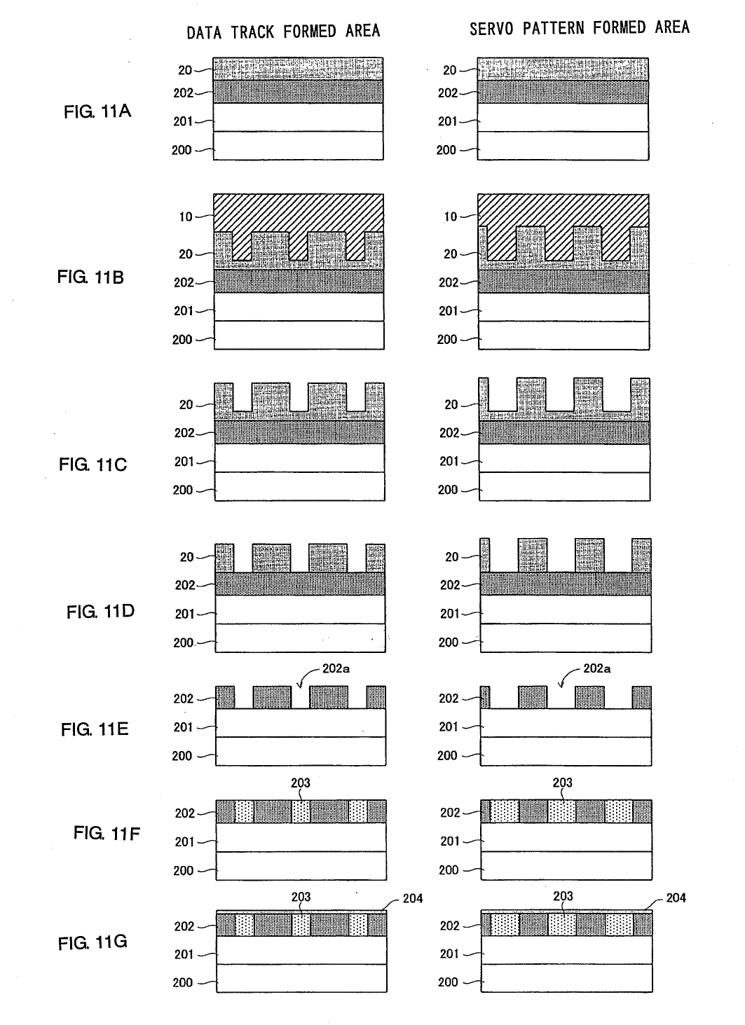

The mold according to the present invention as described above can be used in the manufacture of, for example, discrete track media. FIG. 10 shows the structure of a discrete track medium. The discrete track medium is a record medium configured to have grooves formed between data tracks 100 of magnetic material, where by filling these grooves with nonmagnetic material 101, the data tracks are separated physically and magnetically. With this structure, the record density of discrete track media can be improved without causing a harmful effect such as side write or crosstalk. In this discrete track medium, a servo pattern as position control information such as track addresses and sector addresses as well as the data tracks is formed, and by reading the position control information written in the servo pattern, the magnetic head is positioned with accuracy on the order of a nanometer. The data tracks and the servo pattern may be formed in respective predetermined areas at different pitches respectively. That is, recess/protrusion patterns of different recess/protrusion area ratios may be respectively formed in the data track formed area and the servo pattern formed area. In forming these recess/protrusion patterns, the nano-imprint lithography technology can be used, and the mold according to the present invention described above can be used.

A method of producing a discrete track medium using the mold according to the present invention will be described below with reference to FIG. 11. First, a discrete track medium substrate having a glass substrate 200, a soft magnetic layer 201, and a magnetic layer 202 laid one over another is prepared and is uniformly coated with an NIL resist 20 by, e.g., a spin coat method (FIG. 11 (a)). As the NIL resist 20, light curing resin or thermoplastic resin can be used, and in this embodiment, thermoplastic resin is used. As the thermoplastic resin, for example, polymethyl methacrylate (PMMA) or polystyrene (PS) can be used.

Then, the substrate 30 coated with the NIL resist 20 is heated to about 200° C. to soften the NIL resist 20. Next, the mold 10 according to the present invention is put in contact with the softened NIL resist 20, and by applying pressure, the NIL resist 20 is deformed. Then, keeping the mold pressed, the substrate temperature is lowered to harden the resist 20, thereby transferring the recess/protrusion pattern of the mold 10 to the NIL resist 20 (FIG. 11 (b)). In the mold 10, a recess/protrusion surface made up of two regions different in recess/protrusion area ratio, corresponding to the data track formed area and the servo pattern formed area is formed. Specifically, the region corresponding to the data track formed area has a relatively small recess area percentage, and the region corresponding to the servo pattern formed area has a relatively large recess area percentage. The magnitude relationship in recess/protrusion area ratio between the regions may be the opposite of the above one.

After the NIL resist 20 has hardened sufficiently, the mold 10 is separated from the substrate 30 (FIG. 11 (c)). At this time, a remaining film 20a from the resist 20 is left on parts of the substrate 30 corresponding to the protrusions of the mold 10. The thickness of this remaining film 20a is uniform over the data track formed area and the servo pattern formed area.

Next, the remaining film 20a is completely removed by reactive ion etching (RIE) with O₂ plasma or the like (FIG. 11 (d)). The patterned NIL resist 20 forms a mask on the magnetic layer 202 for forming the data track and the servo pattern.

Then, with the NIL resist 20 as a mask, grooves 202a are formed in the magnetic layer 202 by dry etching (FIG. 11 (e)). Subsequently, the grooves 202a are filled with nonmagnetic material 203 of, e.g., SOG (FIG. 11 (f)). By this means, the float stability of the magnetic head is secured. Then, by forming a protective, lubricant film 204 on the magnetic layer 202, a discrete track medium is finished.

In this way, a discrete track medium having the data track formed area and the servo pattern formed area that are different in track pitch can be produced using a mold according to the present invention.

1. An imprinting mold having a recess/protrusion surface, wherein said recess/protrusion surface is made up of a plurality of regions different in the ratio of the area of recesses to the area of protrusions, and a recess/protrusion surface of a region where said area ratio is small is deeper in recess/protrusion depth than a recess/protrusion surface of a region where said area ratio is large.

2. An imprinting mold according to claim 1, wherein the inner space volume of each recess of said recess/protrusion surface is the same over said plurality of regions.

3. An imprinting mold according to claim 2, wherein at least two of said plurality of regions are different in cross-section shape of said recess/protrusion surface.

4. An imprinting mold according to claim 1, wherein the widths of recesses and protrusions of said recess/protrusion surface are 1 μm or less.

5. A method of producing an imprinting mold according to claim 1, comprising the steps of:
preparing a mold substrate having a transfer layer laid over a substrate material;
preparing a reference mold having a recess/protrusion surface made up of a plurality of recess/protrusion patterns different in the ratio of the area of recesses to the area of protrusions, corresponding to said plurality of regions respectively, where recess/protrusion depth of its recess/protrusion surface is uniform;
pressing said reference mold to transfer the recess/protrusion patterns of said reference mold to said transfer layer and to make the thickness of a remaining film from said transfer layer that is left on parts of said substrate material corresponding to protrusions of said reference mold be different for each of said regions;
coating a coating material over said mold substrate to fill the inner spaces of recesses of the recess/protrusion patterns formed in said transfer layer and then solidifying said coating material;
etching back said coating material until the tops of protrusions of the recess/protrusion patterns formed in said transfer layer are exposed; and
selectively etching said transfer layer with said coating material as a mask.

6. A method of producing an imprinting mold according to claim 1, comprising the steps of:
preparing a mold substrate having a transfer layer laid over a substrate material;
preparing a reference mold having a recess/protrusion surface made up of a plurality of recess/protrusion patterns different in the ratio of the area of recesses to the area of protrusions, corresponding to said plurality of regions respectively, where recess/protrusion depth of its recess/protrusion surface is uniform;
pressing said reference mold to transfer the recess/protrusion patterns of said reference mold to said transfer layer and to make the thickness of a remaining film from said transfer layer that is left on parts of said substrate material corresponding to protrusions of said reference mold be different for each of said regions;
removing all of said remaining film by etching while, by said etching, making the height of a protrusion of the recess/protrusion patterns formed in said transfer layer be different for each of said regions;
coating a coating material over said mold substrate to fill the inner spaces of recesses of the recess/protrusion patterns formed in said transfer layer and then solidifying said coating material;
etching back said coating material until the tops of protrusions of the recess/protrusion patterns formed in said transfer layer are exposed; and
selectively etching said transfer layer with said coating material as a mask.

7. A method of producing an imprinting mold according to claim 1, comprising the steps of:
preparing a mold substrate having a transfer layer laid over a substrate material;
preparing a reference mold having a recess/protrusion surface made up of a plurality of recess/protrusion patterns different in the ratio of the area of recesses to the area of protrusions, corresponding to said plurality of regions respectively, where recess/protrusion depth of its recess/protrusion surface is uniform;
pressing said reference mold to transfer the recess/protrusion patterns of said reference mold to said transfer layer and to make the thickness of a remaining film from said transfer layer that is left on parts of said substrate material corresponding to protrusions of said reference mold be different for each of said regions;
removing part of said remaining film by etching;
coating a coating material over said mold substrate to fill the inner spaces of recesses of the recess/protrusion patterns formed in said transfer layer and then solidifying said coating material;
etching back said coating material until the tops of protrusions of the recess/protrusion patterns formed in said transfer layer are exposed; and
selectively etching said transfer layer with said coating material as a mask.

8. A method of producing an imprinting mold according to claim 1, comprising the steps of:
preparing a mold substrate having a transfer layer laid over a substrate material;
preparing a reference mold having a recess/protrusion surface made up of a plurality of recess/protrusion patterns different in the ratio of the area of recesses to the area of protrusions, corresponding to said plurality of regions respectively, where recess/protrusion depth of its recess/protrusion surface is uniform;
pressing said reference mold to transfer the recess/protrusion patterns of said reference mold to said transfer layer;
removing, by etching, all of a remaining film from said transfer layer that is left on parts of said substrate material corresponding to protrusions of said reference mold;
coating a coating material over said mold substrate to fill the inner spaces of recesses of the recess/protrusion patterns formed in said transfer layer and then solidifying said coating material;
etching back said coating material until the tops of protrusions of the recess/protrusion patterns formed in said transfer layer are exposed; and
selectively etching said transfer layer with said coating material as a mask.

9. A mold producing method according to claim 5, wherein said transfer layer is made of thermoplastic resin.

10. A mold producing method according to claim 9, wherein said thermoplastic resin is polymethyl methacrylate or polystyrene.

11. A mold producing method according to claim 5, wherein said transfer layer is made of light curing resin.

12. A mold producing method according to claim 5, wherein said coating material is thermoset resin.

13. A mold producing method according to claim 12, wherein said thermoset resin is SOG.

14. A mold producing method according to claim 13, wherein said SOG is polysilazane or HSQ.

15. A mold producing method according to claim 5, wherein said coating material is light curing resin.

16. A mold producing method according to claim 5, wherein said coating material is water-soluble resin.

17. A method of producing an imprinting mold having a recess/protrusion surface made up of a plurality of regions different in the ratio of the area of recesses to the area of protrusions, wherein recess/protrusion depth is set such that the volume of the inner space of a recess in a region where said area ratio is small is the same as the volume of the inner space of a recess in a region where said area ratio is large.

18. A imprinting-mold producing method according to claim 17, comprising the steps of:
preparing a mold substrate having a transfer layer laid over a substrate material;
preparing a reference mold having a recess/protrusion surface made up of a plurality of recess/protrusion patterns different in the ratio of the area of recesses to the area of protrusions, corresponding to said plurality of regions respectively;
transferring the recess/protrusion patterns of said reference mold to said transfer layer to make the thickness of a remaining film from said transfer layer that is left on parts of said substrate material corresponding to protrusions of said reference mold be different for each of said regions;
coating a coating material to fill the inner spaces of recesses of the recess/protrusion patterns formed in said transfer layer;
etching back said coating material until the tops of protrusions of the recess/protrusion patterns formed in said transfer layer are exposed; and
selectively etching said transfer layer with said coating material as a mask.
